(19) United States
(12) Patent Application Publication
(10) Pub. No.: US 2006/0184986 A1
(43) Pub. Date: Aug. 17, 2006

(54) Multimedia device

(76) Inventor: Michael Urban, Commuguy (CH)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/227,188

(22) Filed: Sep. 16, 2005

(30) Foreign Application Priority Data
Feb. 16, 2005 (DE) 20 2005 002 561.5
Apr. 26, 2005 (EP) 05 009 160.2

(51) Int. Cl. H04N 5/44; H04N 7/16; H04N 7/173

(52) U.S. Cl. 725/100; 348/725; 725/131; 725/139

(57) ABSTRACT

Multimedia device, suitable for reproducing or recording multimedia data, having a means for connection to an external display apparatus, where the multimedia device has at least one combined input and display means which is set up for displaying a graphical user interface or for reproducing multimedia data.

### BACKGROUND OF THE INVENTION

The present invention relates to a multimedia device, suitable for reproducing and/or recording multimedia data, including means for connection to an external display apparatus.

Multimedia devices of the type mentioned above are already known from the existing art in various embodiments.

One drawback of the known multimedia devices is that they are frequently relatively complicated and inconvenient to operate. In addition, the known multimedia devices always need to be connected to an external display apparatus, such as a television set, a monitor or the like, in order to be able to display a graphical user interface for the multimedia device, for example, or to be able to reproduce multimedia data, particularly video data.

This is where the present invention comes in.

The present invention is based on the object of proposing a multimedia device which can be used and operated easily and conveniently even without connection to an external display apparatus or without activation of the external display apparatus.

### SUMMARY OF THE INVENTION

The invention proposes that the multimedia device have at least one combined input and display means which is set up for displaying a graphical user interface and/or for reproducing multimedia data. A fundamental advantage of the inventive solution is that no external display apparatus, such as a television set, a monitor or the like, needs to be connected to the multimedia device or switched on in order for the graphical user interface of the multimedia device to be able to be displayed and used, and possibly also for multimedia data of all types, particularly including video data, to be able to be reproduced. The at least one combined input and display means allows simple and convenient operation of the multimedia device. The use of a graphical user interface particularly allows intuitive operation and control of a multiplicity of functions which are provided by the multimedia device. The at least one combined input and display means can be fitted, by way of example, permanently on the multimedia device, particularly on a front face of a housing for the multimedia device.

In one preferred embodiment, it is proposed that the at least one combined input and display means be fitted on the multimedia device so as to be able to pivot around at least one essentially horizontal axis. The user of the multimedia device can thus pivot the at least one combined input and display means when required in order to make the use of the combined input and display means more convenient, for example. The pivotability of the combined input and display means has the additional advantage that if unfavorable light conditions arise, which can be caused by light hitting the combined input and display means directly, for example, the viewing angle of the combined input and display means can be altered at least with respect to an essentially horizontal axis and hence can be matched to the individual needs of the user.

In one advantageous embodiment, provision may also be made for the at least one combined input and display means to be fitted on the multimedia device so as to be able to pivot around at least one essentially vertical axis. This measure thus also allows the viewing angle at which a user views the combined input and display means to be matched to the needs of the user with respect to an essentially vertical axis of rotation. As already mentioned above, this may be advantageous particularly under unfavorable light conditions, since the viewing angle can be set individually and matched to the lighting situation as appropriate.

In line with one particularly preferred embodiment, it is proposed that the at least one combined input and display means be fitted on the multimedia device detachably. This embodiment provides particular flexibility and allows the user to use the combined input and display means when it is fitted on or detached from the multimedia device.

In line with the invention, it is proposed that the at least one combined input and display means have a housing. The housing simplifies the handling of the at least one combined input and display means particularly when the latter is fitted on the multimedia device detachably.

In one particularly advantageous embodiment, it is proposed that the multimedia device have locking means, suitable for fitting the housing on the multimedia device detachably. The locking means make it possible, in particular, for the housing of the at least one combined input and display means to be fitted on the multimedia device securely.

To improve the handling of the at least one combined input and display means, it is possible for the housing to have a number of grip elements.

In one particularly preferred embodiment, the grip elements are in a form such that they are suitable for unlocking the locking means. By way of example, the grip elements may be in a form such that pressure on the grip elements allows the locking means to be unlocked and the housing to be subsequently removed from a corresponding housing receptacle, which may be provided on the front face of the multimedia device, for example. This makes it possible to dispense with a separate unlocking mechanism, for example.

In one particularly advantageous embodiment, the multimedia device has means for wireless communication with the at least one combined input and display means. In this way, the at least one combined input and display means can be operated without cables, as a result of which the handling and operation of the combined input and display means can be made more convenient. In this exemplary embodiment, the combined input and display means allows, inter alia, remote control of the multimedia device using the graphical user interface. In addition, multimedia data of all types, for example video data, can be transmitted to the combined input and display means without cables and can be reproduced using the combined input and display means.

The combined input and display means, which is fitted on the multimedia device detachably, is preferably coupled to the multimedia device such that the primary computation power which is required for operating the combined input and display means is provided by the processor means in the multimedia device. Preferably, during operation, only the screen content which is intended to be shown on the combined input and display means is transmitted from the multimedia device to the combined input and display means. Accordingly, control inputs made by a user are transmitted from the combined input and display means to the multimedia device. The combined input and display means thus does not necessarily require powerful processor means. The memory requirement of the combined input and display means is also relatively low. The combined input and display means can thus be produced relatively inexpensively. To relieve the load on the processor means in the multimedia device and/or to increase the operating speed of the combined input and display means, the combined input and display means may in principle also have powerful processor means.

In one particularly advantageous embodiment, it is proposed that the at least one combined input and display means have first transmission and reception means and that the multimedia device have second transmission and reception means, the first and second transmission and reception means being set up for wirelessly connecting the multimedia device to the at least one combined input and display means. Using a suitable data transmission protocol, the multimedia device and the combined input and display means can communicate with one another continuously, so that simple and convenient operation of the multimedia device using the combined input and display means is possible and multimedia data, particularly video data, can be transmitted from the multimedia device to the combined input and display means and can be reproduced by the latter.

Preferably, the wireless connection is a radio link, particularly a radio link based on the IEEE 802.11 transmission standard. In this way, a “WLAN”(Wireless Local Area Network) connection can be set up between the multimedia device and the combined input and display means. The data transmission protocol used may be the “remote desktop protocol” for example. The WLAN connection also allows operation of the at least one combined input and display means at a greater distance from the multimedia device. By way of example, the combined input and display means and the multimedia device can be operated simultaneously in different rooms of a building. Radio links based on the IEEE 802.11 transmission standard also provide sufficient bandwidth, which means that it is also readily possible for more extensive multimedia data to be transmitted from the multimedia device to the combined input and display means.

In one particularly preferred embodiment, the combined input and display means comprises at least one touch-sensitive input and display means. The at least one touch-sensitive input and display means allows simple and convenient operation of the multimedia device.

In this case, provision may be made for the touch-sensitive input and display means to be set up for operation using a finger and/or using a stylus.

Preferably, the touch-sensitive input and display means comprises at least one touch-sensitive screen. Touch-sensitive screens can be manufactured relatively inexpensively.

### BRIEF DESCRIPTION OF THE DRAWINGS

The text below gives a more detailed description of two exemplary embodiments of a multimedia device with reference to the appended drawings, in which

FIG. 1 shows a front view of a multimedia device based on a first embodiment of the present invention; and

FIG. 2 shows a front view of a multimedia device based on a second embodiment of the present invention.

### DETAILED DESCRIPTION OF THE INVENTION

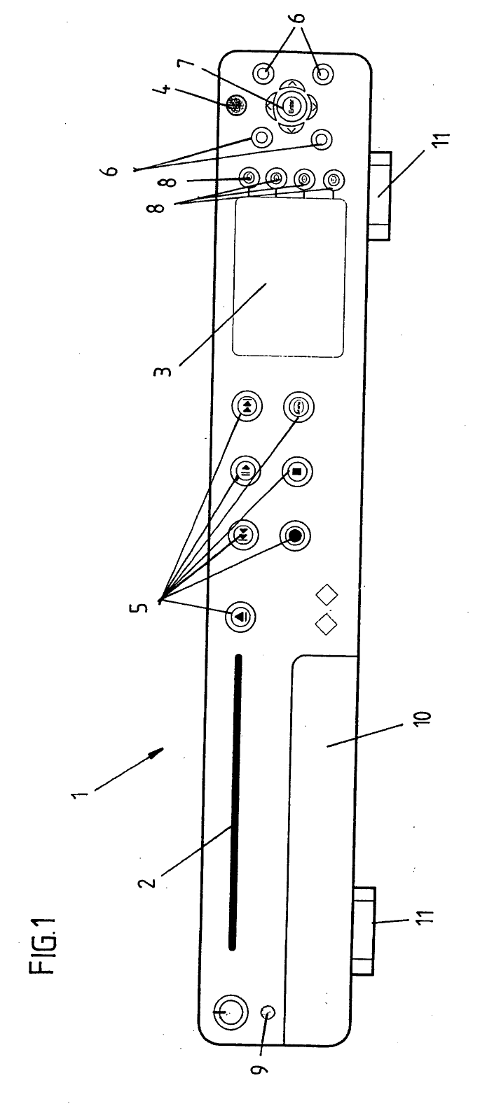

Reference is first made to FIG. 1, which shows a first embodiment of a multimedia device 1. In this exemplary embodiment, the multimedia device 1 has a main board, central processor means, graphics processor means, memory means, at least one hard disk drive and an optical disk drive 2, inter alia, which are accommodated in a housing for the multimedia device 1. The optical disk drive 2 may preferably be a DVD drive which can read and preferably also write information to DVD media of all types and also CD media. In this case, it is preferably possible to use an optical disk drive 2 of compact design with low power consumption in order to reduce the power consumption and the operating noise of the multimedia device 1. It is alternatively also possible for an optical disk drive 2 with relatively high power consumption and of relatively large design to be used. The optical disk drive 2 can preferably read and write information to all popular formats of optical disks. In this case, provision can be made for what are known as dual layer media, double layer media and blue ray disk media also to be able to be read and have information written to them using the optical disk drive 2.

Preferably, system components which have been developed particularly for power-saving fixed-location computers or portable computers are used for the multimedia device 1, in order to reduce the power consumption and the noise produced during operation of the multimedia device 1. With appropriate choice of system components, the multimedia device 1 can also be produced without an active fan and can be cooled passively.

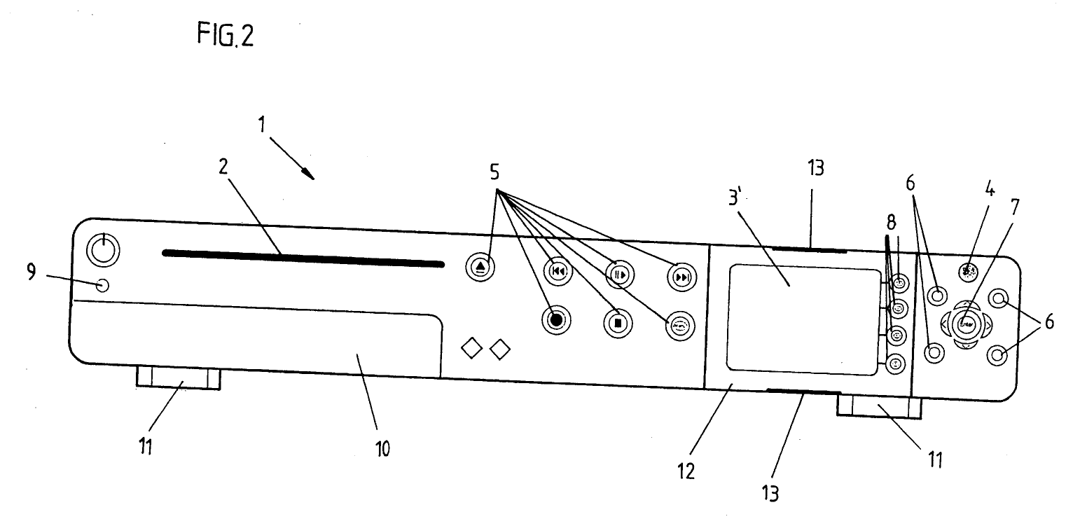

The multimedia device 1 has a combined input and display means which in this exemplary embodiment may be a touch-sensitive input and display means 3, which can be operated using a stylus (not shown explicitly here), which preferably has a plastic tip in order to avoid damaging the surface of the touch-sensitive input and display means 3, and/or using the user's finger. As shown in the first exemplary embodiment here, the touch-sensitive input and display means 3 can be fitted on a front face of the housing of the multimedia device 1 permanently. The touch-sensitive input and display means 3 may also be fitted on the front face of the multimedia device 1 so as to be able to pivot, particularly so as to be able to pivot upward around an essentially horizontal axis. Provision may also be made for the touch-sensitive input and display means 3 to be fitted on the multimedia device 1 so as to be able to pivot around an essentially vertical axis. In one alternative embodiment, which is shown in FIG. 2 and is described in more detail below, the touch-sensitive input and display means 3 may be fitted on the multimedia device 1 detachably. The touch-sensitive input and display means 3 can show, in particular, multimedia data of all types, particularly text, graphics, images, electronic program information or else video data and also preferably a graphical user interface for the multimedia device 1.

The touch-sensitive input and display means 3, which is in the form of a touch-sensitive screen, in particular, may have a graphical resolution of 320 ×240, 640 ×480, 800 ×600 or 1024 ×768 pixels, for example. Depending on the desired height of the housing for the multimedia device 1, the size of the touch-sensitive input and display means 3 and/or the graphical resolution can be adapted accordingly. The touch-sensitive input and display means 3 can be based, by way of example, on CSTN technology, on TFT-LCD technology, on amorphous silicon TFT-LCD technology, on low-temperature polysilicon TFT-LCD technology, on BEM technology or on OLED technology.

During operation of the multimedia device 1, it is possible for a graphical user interface, for example, to be shown on the touch-sensitive input and display means 3 without the need for an external display unit, such as a television set, a monitor or the like, to be connected or switched on. Using the stylus and/or a finger, the user can make control inputs on the touch-sensitive input and display means 3, and these control inputs can be processed using suitable software. By way of example, this allows recording times to be input for radio or television transmissions which are intended to be recorded using the multimedia device 1.

The touch-sensitive input and display means 3 can show the user interface, graphical information, text information and/or multimedia data of all types in appropriately adapted and scaled form which can optionally also be shown simultaneously on an activated external display apparatus, such as on a television set, monitor or the like which has been switched on. Provision may also be made for the touch-sensitive input and display means 3 to display or reproduce graphical information, text information and/or multimedia data which differ from those which are shown simultaneously on the television set, monitor or the like which has been switched on. By way of example, the television set can display multimedia data (for example video data), while the graphical user interface, electronic program information, current news etc. are shown simultaneously on the touch-sensitive input and display means 3. It should be emphasized once again at this point that an external display apparatus does not need to be connected or switched on in order for the user interface, multimedia data and the like to be able to be displayed or reproduced on the touch-sensitive input and display means 3.

The touch-sensitive input and display means 3 thus particularly allows convenient control and/or programming of the multimedia device 1 without the need for the multimedia device 1 to be necessarily connected to an external display apparatus or for the latter to be switched on. The touch-sensitive input and display means 3 can therefore be addressed as a second display apparatus by the software of the multimedia device 1 and can display the graphical user interface, for example. The touch-sensitive input and display means 3 is thus not only used to display graphical information but also provides a convenient way of controlling and/or programming the multimedia device 1 using finger or stylus input.

To allow the touch-sensitive input and display means 3 to be operated as exactly and conveniently as possible, it is preferably possible to use the stylus (not shown explicitly here). When not in use, the stylus can be accommodated in a stylus receptacle 4 which is arranged next to the touch-sensitive input and display means 3.

The multimedia device 1 in this exemplary embodiment also has four programmable key elements 8 at the side next to the touch-sensitive input and display means 3, said key elements being respectively arranged one below the other. It is also possible for more than four programmable key elements 8 to be provided, the number of programmable key elements 8 depending, in particular, on the size of the touch-sensitive input and display means. Preferably, the function of each individual programmable key element 8 can be displayed directly on the touch-sensitive input and display means 3. The respective functions of the programmable key elements 8 may already have been preprogrammed by the manufacturer, or else can be set or changed by the user of the multimedia device 1 when needed.

In addition, the front face of the housing of the multimedia device 1 is provided with a plurality of fast control keys 5 which are provided for controlling the playback and/or record functions of the multimedia device 1 which are used by the users most frequently. By way of example, the fast control keys 5 can be used to call a menu or to start, interrupt or stop recording or playing back multimedia data. In radio or television mode, it is possible to change over between different stations or to start, interrupt or stop recording radio or television transmissions on the hard disk or on an optical disk which is in the optical disk drive 2 by pressing a key, for example.

In this exemplary embodiment, the front face of the housing of the multimedia device 1 is provided with further function keys 6, at least some of which can be preprogrammed or may be user-programmable, and also a number of navigation keys 7 which allow the user to control and select different menu functions intuitively.

Arranged behind a hinged cover 10, which in this exemplary embodiment is arranged on the front face of the housing of the multimedia device 1 and can be pivoted forward, there may be, by way of example, at least one PCMCIA slot, a CAM module slot, a memory card read/write apparatus for all conventional memory card formats, at least one USB connection, audio and video inputs, which may also be in digital form, and a headphone output to which conventional headphones can be connected. In addition, there may be at least one FireWire connection based on the IEEE 1394 standard behind the hinged cover 10, to which FireWire connection it is possible to connect a digital video camera, for example. This or another point on the multimedia device 1 may also have connections for a conventional computer keyboard and/or a computer mouse. Alternatively, the hinged cover 10 may also be in the form of a sliding cover or a retractable cover in order to improve the ergonomics of the multimedia device 1.

It is also possible to use a remote control (likewise not shown explicitly here) in order to call a multiplicity of standard functions of the multimedia device 1. To this end, the multimedia device 1 in this exemplary embodiment comprises reception means 9 on the front face of the housing, said reception means being suitable for receiving control information from the remote control. If the reception means 9 are set up appropriately, the control information can be transmitted from the remote control to the reception means 9 of the multimedia device 1 using, by way of example, infrared, Bluetooth, or alternatively using radio waves—for example at transmission frequencies of 422 MHz or 844 MHz-and can be converted into control information in appropriate fashion. As an alternative or in addition to the remote control, a computer keyboard and preferably also a computer mouse or a computer keyboard with an integrated computer mouse which the user can use to make inputs can be connected to the multimedia device 1 without cables, particularly using the reception means 9, or with cables.

The multimedia device 1 preferably comprises first transmission and reception means for a wireless WLAN (Wireless Local Area Network) connection which are set up for a wireless WLAN connection to external appliances with WLAN capability. In this case, the radio transmission is based on known transmission standards (for example on the IEEE 801.11b standard or on the IEEE 801.11g standard).

In addition, the multimedia device 1 may also have Bluetooth communication means, which allow communication with external appliances on which the Bluetooth communication standard is likewise implemented.

On the back of the housing, for example, the multimedia device 1 may have at least one network connection for a wired network (LAN, Local Area Network), an analog modem connection, a microphone connection, a digital HDMI input for HDTV receivers or HDTV players, a digital HDMI output for display apparatuses suitable for HDTV, audio outputs, optical and/or coaxial digital inputs, optical and/or coaxial digital outputs, a VGA connection, which is suitable for connecting a conventional computer monitor, for example, a digital DVI output, which is suitable for connecting a conventional LCD screen with a digital input, for example, a serial RS-232 connection, a SCART input, a SCART output, a video and/or S-video output, at least one USB connection and at least one FireWire connection. As an alternative to the SCART connections, it is also possible to use RCA plug connections. In addition, a PCMCIA slot may be arranged on the back of the housing of the multimedia device, said PCMCIA slot being provided for an analog and/or digital TV/radio reception module, in particular. The multimedia device 1 may also have an RGB component input and an RGB component output. The RGB component input may have an HDTV receiver or a DVD player connected to it, for example. The RGB component output may have television sets or projectors connected to it, for example. For the input and output of the RGB, S-video or video signals, SCART connectors are used in Europe. Outside of Europe, RCA connectors are essentially used. Component signals are output or input via RCA connectors in Europe and outside of Europe.

FIG. 2 shows a front view of a second embodiment of the multimedia device 1. The variant shown in FIG. 2 differs from the first exemplary embodiment in that the touch-sensitive input and display means 3′ is fitted on the front face of the housing of the multimedia device 1 detachably. The touch-sensitive input and display means 3′ has a separate housing 12, which in this exemplary embodiment has two grip elements 13 and four programmable key elements 8. It is also possible for more than four programmable key elements 8 to be provided. In this case, the number of programmable key elements 8 is dependent particularly on the size of the touch-sensitive input and display means 3. With the aid of locking means (not shown explicitly here), the housing 12 of the removable touch-sensitive input and display means 3′ can be fitted on the multimedia device 1 detachably. The locking means can be unlocked by pressing on the grip elements 13, for example, or in another way so that the touch-sensitive input and display means 3′ can be removed from the multimedia device 1.

In terms of its functionality, the removable touch-sensitive input and display means 3′ corresponds to the permanently installed touch-sensitive input and display means 3 which has already been described in detail above in connection with the first exemplary embodiment. In addition, an additional receptacle (not shown explicitly here) for the stylus can be provided in the housing 12 of the removable touch-sensitive input and display means 3′ in this exemplary embodiment.

For supplying voltage, the removable touch-sensitive input and display means 3′ preferably has a chargeable voltage source which can be recharged particularly when the removable touch-sensitive input and display means 3′ is fitted on the multimedia device 1.

In addition, the removable touch-sensitive input and display means 3′ comprises first transmission and reception means which are set up for a wireless network connection (WLAN connection) to the multimedia device 1. Between the multimedia device 1 and the removable touch-sensitive input and display means 3′, there may thus be a WLAN connection when the removable touch-sensitive input and display means 3′ has been removed from the multimedia device 1. In this exemplary embodiment, the multimedia device 1 may comprise second transmission and reception means which are set up for a wireless network connection based on the WLAN transmission standard. It is thus possible to set up what is known as an ad-hoc WLAN connection (1:1 connection) between the multimedia device 1 and the removable touch-sensitive input and display means 3′. It is thus possible to transmit extensive multimedia data (for example video data) by WLAN connection on account of the relatively high available bandwidth.

Alternatively, the communication between the multimedia device 1 and the removable touch-sensitive input and display means 3′ may also take place using a Bluetooth connection. On account of the relatively small bandwidth, the wireless Bluetooth connection is not suitable for transmitting extensive multimedia data, however.

One advantage of the second embodiment is, in particular, that it is possible to operate the multimedia device 1 remotely using the removable touch-sensitive input and display means 3′, which can display the user interface of the multimedia device 1. In addition, multimedia data can be transmitted by a wireless network connection, preferably by WLAN connection, from the multimedia device 1 to the removable touch-sensitive input and display means 3′ and possibly also in the opposite transmission direction, which means that the removable touch-sensitive input and display means 3′ may also be used, by way of example, at a relatively long distance from the multimedia device 1 (for example in an adjacent room) to display multimedia data, the user interface etc.

To reproduce audio data, the removable touch-sensitive input and display means 3′ may have at least one loudspeaker and/or one headphone connection.

The other components and connections of the multimedia device 1 based on the second embodiment correspond to those in the first exemplary embodiment. They are therefore not explicitly explained again at this point.

The multimedia device 1 disclosed in the two exemplary embodiments presented here may preferably be in a form such that it is suitable for the areas of use listed below, inter alia:
CD player and CD recorder;
DVD player and DVD recorder;
hard disk player and hard disk recorder;
playing back and recording data in MP3, WMA, WAV format and also in MPEG1, MPEG2, MPEG3, MPEG4, DivX, VCD and Xvid format and/or in other compression formats;
displaying images and photos;
receiving and recording analog and/or digital radio and/or television programs using an antenna, cable or satellite;
receiving electronic program information;
image, film and radio reception over the Internet using a record function;
receiving new information (news, weather, etc.);
e-mail, MMS or SMS reception;
Internet access,
telephony using Voiceover IP.

1. A multimedia device, suitable for reproducing and/or recording multimedia data, comprising means for connection to an external display apparatus, wherein the multimedia device has at least one combined input and display means which is set up for displaying a graphical user interface for the multimedia device or for reproducing multimedia data.

2. The multimedia device as claimed in claim 1, wherein the at least one combined input and display means is fitted on the multimedia device so as to be able to pivot around at least one essentially horizontal axis.

3. The multimedia device as claimed in claim 1, wherein the at least one combined input and display means is fitted on the multimedia device so as to be able to pivot around at least one essentially vertical axis.

4. The multimedia device as claimed in claim 1, wherein the at least one combined input and display means is detachably fitted on the multimedia device.

5. The multimedia device as claimed in claim 1, wherein the at least one combined input and display means has a housing.

6. The multimedia device as claimed in claim 1, wherein the multimedia device has locking means, suitable for detachably fitting the housing on the multimedia device.

7. The multimedia device as claimed in claim 5, wherein the housing has a number of grip elements.

8. The multimedia device as claimed in claim 7, wherein the grip elements are in a form such that they are suitable for unlocking the locking means.

9. The multimedia device as claimed in claim 1, wherein the multimedia device has means for wireless communication with the at least one combined input and display means.

10. The multimedia device as claimed in claim 1, wherein the at least one combined input and display means has first transmission and reception means, and wherein the multimedia device has second transmission and reception means, with the first and second transmission and reception means being set up for wirelessly connecting the multimedia device to the at least one combined input and display means.

11. The multimedia device as claimed in claim 10, wherein the wireless connection is a radio link, or a radio link based on the IEEE 802.11 transmission standard.

12. The multimedia device as claimed in claim 1, wherein the combined input and display means comprises at least one touch-sensitive input and display means.

13. The multimedia device as claimed in claim 12, wherein the at least one touch-sensitive input and display means is set up for operation using a finger, a stylus, or a combination thereof.

14. The multimedia device as claimed in claim 12, wherein the at least one touch-sensitive input and display means comprises at least one touch-sensitive screen.
